(19) United States
(12) Patent Application Publication
(10) Pub. No.: US 2009/0090756 A1
(43) Pub. Date: Apr. 9, 2009

(54) Dashboard gauge display apparatus

(75) Inventors: Gregory E. Day, Great Falls, VA (US); James J. Tily, Beltsville, MD (US)

Correspondence Address: WILLIAMS MULLEN, 222 CENTRAL PARK AVENUE, SUITE 1700, VIRGINIA BEACH, VA, 23462, US

(73) Assignee: Gauge Works, LLC

(21) Appl. No.: 11/973,413

(22) Filed: Oct. 9, 2007

(51) Int. Cl. B60R 7/06

(52) U.S. Cl. 224/483

(57) ABSTRACT

An assembly for attaching gauges or other accessories to vehicles provides a rampart member for securing the assembly to a vehicle surface and a parapet member secured to the rampart member for adequately engaging a vehicle surface and covering any instruments that may be inserted and received in the rampart member for display.

### FIELD OF THE INVENTION

The present invention relates generally to an apparatus for mounting items to, and displaying items on, vehicles. More particularly, the invention relates to a rigid and versatile apparatus for supporting instruments or other items from available areas of vehicles, such as the area in front of and on top of the dashboard.

### BACKGROUND

Many forms of personal transportation lack desired controls, indications, or accessories suited to the personal tastes of the individual or individuals using the transportation. Automobile manufacturers provide a basic level of indicators and displays (e.g., speedometer, engine temperature, and fuel level, with warning lights for various other indicators) and forego the addition of ancillary instruments and gauges to keep their costs low. Simple efforts at adding gauges and other instruments to a vehicle's interior often sacrifice the stability of the factory equipment to which the instruments are attached, and further sacrifice the safety of the passengers by not adequately supporting the added instruments.

These problems provide opportunities for creative after-market solutions. Because of the expense of design and production, after-market manufacturers try to design products applicable to a wide variety of makes or styles of vehicles. Therefore, it is important that after-market solutions be versatile, capable of suiting most drivers regardless of the vehicle. Ideally, the flexibility of orientation and location would help a variety of drivers of a single vehicle to achieve spatial compatibility with the installed indications. Such products should also be effective, safe, inexpensive, and easy for the driver to install.

Most vehicles feature some exposed, available surface. For example, vehicles used in motor sports are likely to provide roll over protection through tubular roll bars or cages; additionally, in some of these vehicles the A-pillar is also an exposed tube. Larger vehicles, such as boats and automobiles may have free surfaces on dashboards or consoles in front and below the driver's field of view, as well as on the windshield or on the roof in front and above the driver's field of view. Such spots provide an opportunity for mounting one or more gauges, controls, or accessories.

Different drivers, and even different positions of a single driver can require a broad range of adjustment to preserve spatial compatibility of an important gauge or indication. Additionally, items such as gauges typically must be connected by wiring to the equipment measuring the given vehicle performance or other parameter to be displayed by the gauge. This requires provisioning for wire hookup and discrete wire covering.

### SUMMARY OF THE INVENTION

The present invention is directed to a dashboard gauge display apparatus for overcoming the above and other challenges. In one embodiment, the invention includes a rampart member having one or more gauge display frame elements and a parapet member providing an upper enclosure for the rampart member. The present invention can be mounted in the center of a vehicle dashboard between the driver and passenger cowls. The present invention can be used to mount one, two, three or more gauges therein, and the gauges can be angled towards the driver.

### BRIEF DESCRIPTION OF THE DRAWINGS

FIG. 1 is a top right front perspective view of one embodiment of the dashboard gauge display apparatus of the present invention.

FIG. 2 is a front elevational view of the apparatus of FIG. 1.

FIG. 3 is a bottom right front perspective view of the rampart member of the present invention.

FIG. 4 is a right side view of the apparatus of FIG. 1.

FIG. 5 is a bottom plan view of the apparatus of FIG. 1.

FIG. 6 is a top plan view of the parapet member of the present invention an illustrative schematic view showing the gauge frame member being installed in a vehicle interior.

### DETAILED DESCRIPTION

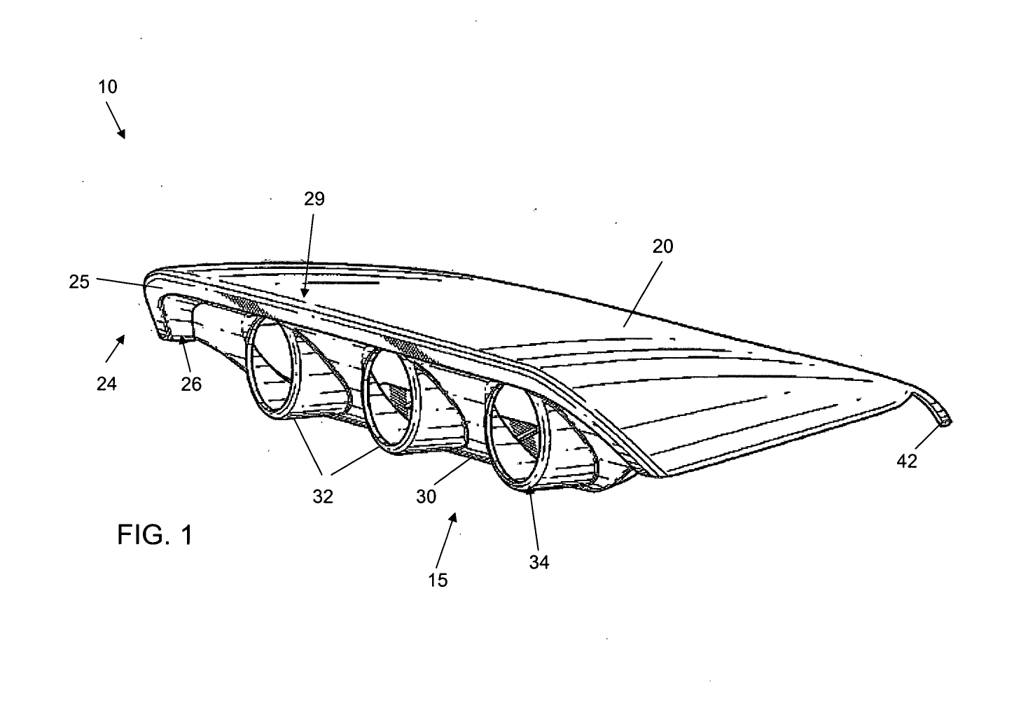

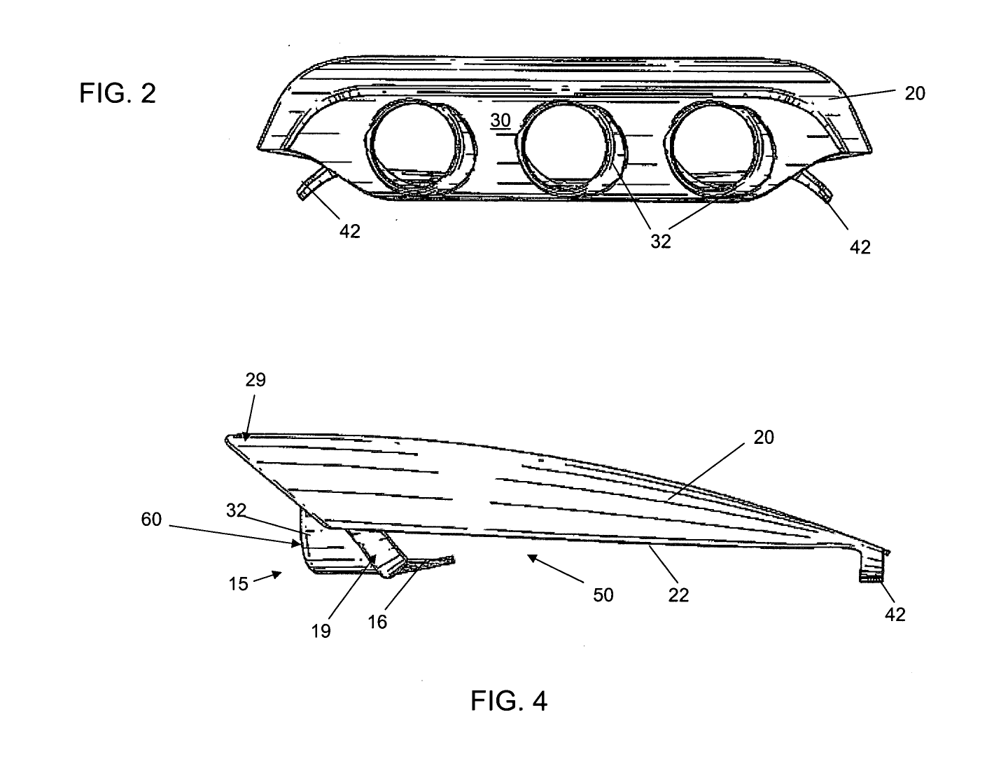

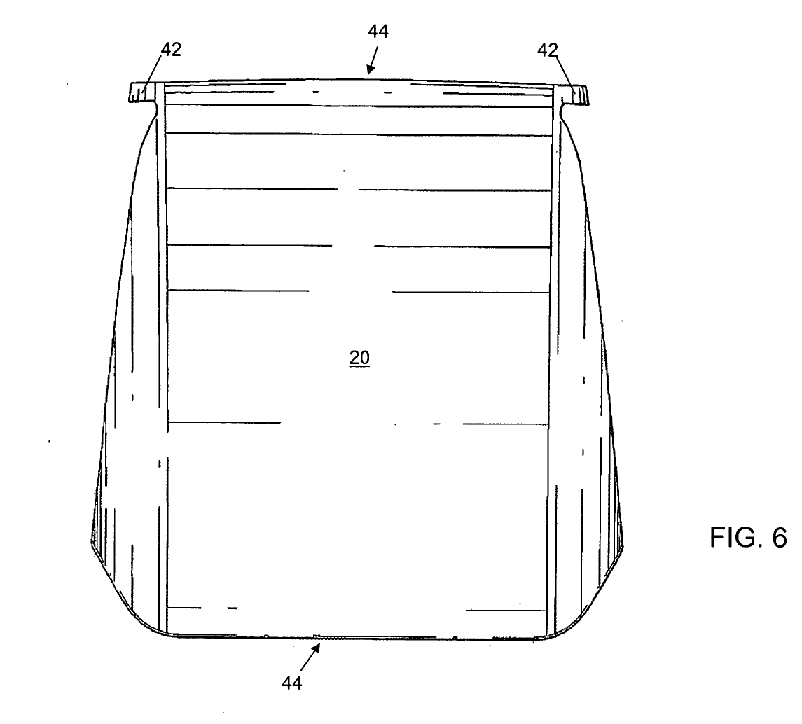

With reference to the drawings, as shown in FIGS. 1 through 6, there is provided a dashboard gauge display apparatus 10 having a rampart member 15 and a parapet member 20. The rampart member 15 and parapet member 20 have bottom edges 16, 22, respectively, that can be used to secure the assembly of the present invention to a mounting surface of a vehicle, such as atop an existing vehicle dashboard, as described hereinafter.

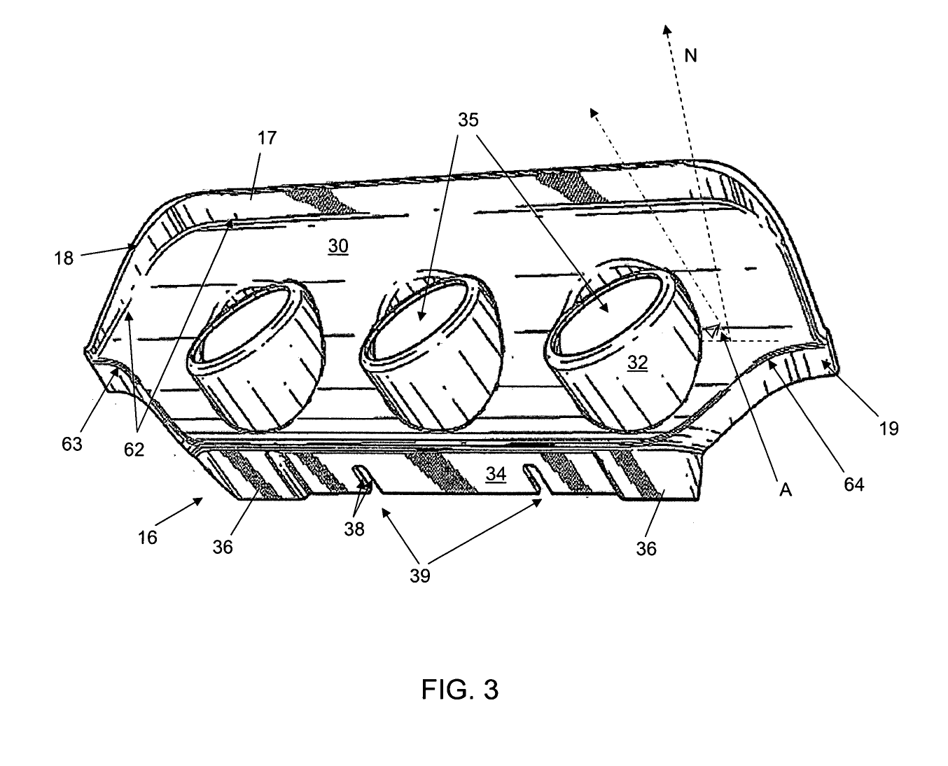

As shown in FIGS. 1, 2 and 3, the rampart member has a face portion 30 into which can be formed one or more gauge display frame members 32. The frame members 32 can have outer surfaces (e.g., 60 in FIG. 4) that are substantially coplanar with the face portion 30, or the frame members can extend outwardly from the face portion 30 as shown in FIGS. 1 through 3 such that outer surfaces or rims are not coplanar with the face portion. In one embodiment of the present invention, the gauge display frame members extend outwardly in a substantially cylindrical form and at a non-perpendicular angle to the face portion 20 (i.e., at an angle A different than the normal angle represented by normal line N in FIG. 3). Face portion can be substantially coplanar with the vertical face of an original equipment dashboard on which the apparatus of the present invention can be mounted, and further can extend at a substantially perpendicular angle to the top, more substantially horizontal dashboard mounting surface. The angle(s) of presenting the face portion 30 and the one or more gauge display frame members can enable a better visual appearance or visual sighting for drivers and/or passengers of the vehicle in which the present invention is installed.

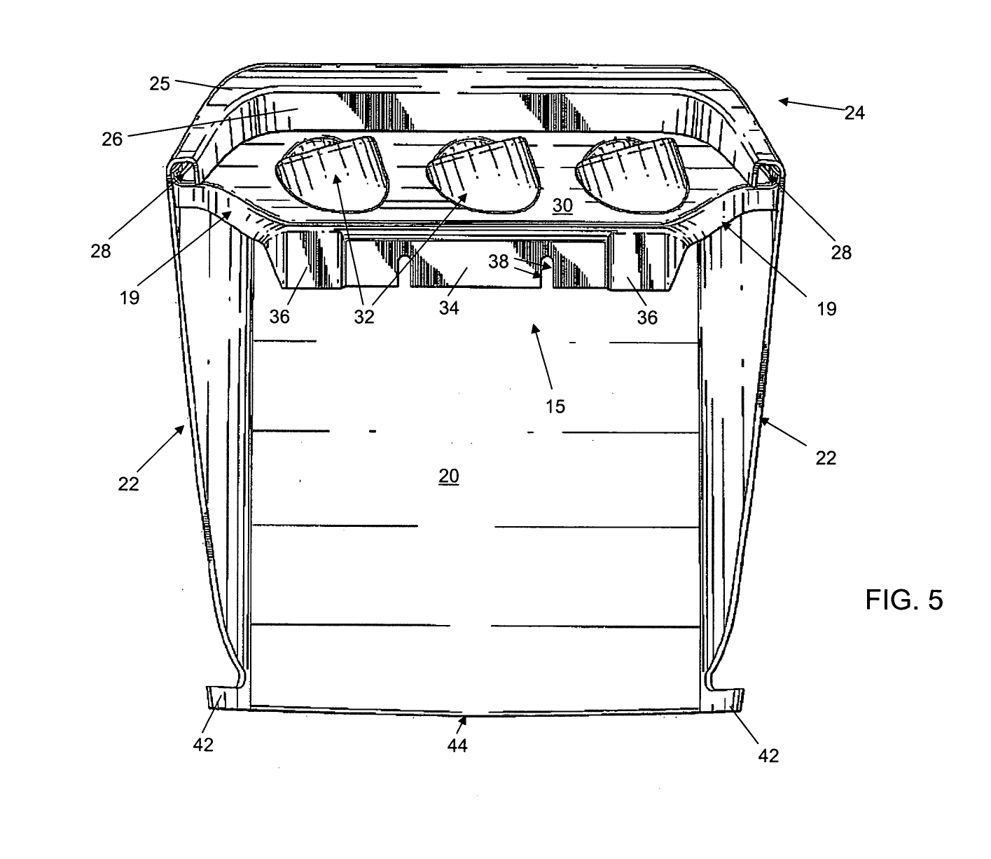

As shown in FIGS. 1 and 5, the parapet member 20 includes a front shroud portion 24 that extends outwardly of the face portion 30 of the rampart member 15 when the apparatus of the present invention is assembled. The shroud portion 24 includes a front facing wall portion 25 and a rampart engaging wall 26 bent back from the front facing wall so as to be substantially parallel with the top surface 29 of the parapet member 20. The front facing wall portion 25 and rampart engaging wall 26 form a cavity 28 that allows rampart member to fit through for secure engagement of the apparatus as described more completely hereafter.

As shown in FIGS. 3 through 5, the rampart member 15 includes a head platform portion 17 extending from the top edge 62 of the face 30. In one embodiment of the present invention, the head platform portion 17 is integrally formed with and extends from the full length of the top edge 62 of the face portion 30. The head platform portion 17 has an outer edge 18 and can rest against the rampart engaging wall 26 of the shroud member 24 when engaged with the parapet member 20 as shown in FIG. 5. The rampart member further includes side beard segments 19 and a bottom segment 16 which can provide flat surfaces for mounting to a dashboard, for example. The side beard segments 19 and the bottom segment 16 are integrally formed with the face portion, and the side beard segments extend outwardly from a left 63 and right 64 edge of the face portion. In one embodiment, bottom segment 16 comprises a pair of bottom tabs 36 and a raised bottom platform 34, wherein the bottom platform 34 is formed with indented edges 38 to provide one or more tabs 39. The bottom platform can be raised and the tabs provided to accommodate temporary attachment of a stud plate of metal or other material when mounting the apparatus of the present invention to the dashboard of an automobile, for example. Tabs can also be used to guide wires extending from gauges mounted within the present invention.

The face portion 30 is formed with one or more substantially circular, part-cylindrical and/or other shaped gauge frame members 32 so as to provide one or more openings 35 therein (i.e., through the face portion), through which an installed gauge or other instrument may be viewed, for example. In one embodiment, a frame member edge 34 forms the perimeter of the respective opening 35 and the frame member body 32 and edge 34 are configured to receive and/or retain a portion of the gauge or instrument for display. In this way, the face of the gauge or other instrument can extend through the opening, with the remaining body portion of the gauge residing in the cavity created by the mating of the parapet member and the rampart member, supported in one embodiment at least in part by the frame member body 32. In the embodiments of the invention with gauge frame members, while the frame members can be constructed to lie in parallel planes, the invention can be constructed such that any two or more frame members can lie in parallel planes, or such that no two frame members lie in parallel planes. In another embodiment, the frame member is not provided in substantially circular or part-cylindrical form, but rather in another geometric form provided with an opening for housing an item which is not substantially cylindrical or circular in cross-section, for example.

The broader surface areas of rampart member and parapet member enable the mating of the rampart member with the parapet member through a variety of mating techniques, such as with glue, double-sided tape, hook-and-loop type fasteners such as Velcro™, screws, single-sided tape and other known adhesives. In one embodiment, a chemical comprising methylene chloride can be employed which acts to weld the members together.

When the rampart member is securely engaged with the parapet member, an opening 50 is created, as shown in FIG. 4. In operation, gauges and other instruments may be positioned within the cavity portion prior to or after the sealing of rampart member with gauge display member, and any wiring from the gauge(s) or instrument(s) is channeled therethrough, and finally attached to the instrument or other device for which a connection is required. It will be appreciated that references herein to the term “gauge” or “instrument” can mean any of a variety of gauges, instruments, displays, lights, dials, needles, indicators or other item that can be used to reveal a characteristic, status, property, measurement or reading which a driver or passenger of a vehicle may find desirable to gain knowledge of or obtain. This should not be limited to vehicle performance gauges such as a tachometer and similar items. For example, in one embodiment of the invention, an instrument such as a wireless or satellite radio may be retained within the assembly of the present invention. It will further be appreciated that the term “gauge display member” should not be limited to a member for displaying only gauges.

The combined parapet member and rampart member can be secured within a vehicle using a variety of attachment methods and devices. In one embodiment, an adhesive such as two-sided tape, hook-and-loop fasteners, glue or other suitable bonding adhesive can be placed on the dashboard and/or the back 44 and/or bottom 22 of parapet member, as well as bottom 16 and side beard portions 19 of rampart member to adhere the device to the dashboard. In another embodiment, a first bracket member (not shown) can be adhered to a dashboard while a cooperating second bracket member (not shown) is adhered to the back 44 of parapet member. Then, the brackets are cooperatively engaged to securely support the device on the dashboard of a vehicle. It will be appreciated that a combination of the above methods and devices may be employed as necessary.

When the assembly is secured within the vehicle, the surfaces 16, 19 and 22 of the apparatus 10 align with the dashboard or other support surface to provide a mating seam. In this way, the invention can provide an aesthetically appealing “factory look” while concealing unsightly wiring and other components maintained within the cavity of the assembly.

It will be appreciated that the gauge display assembly of the present invention may thereby be located at various locations within the vehicle depending upon the user's taste. In one embodiment, a kit can be provided in connection with the invention, including the gauge display member, rampart member, adhesive and/or other attachment mechanisms for securing the rampart member to the vehicle interior as well as for securing the rampart member to the gauge display member.

In constructing the present invention, the rampart member and parapet member can be formed by creating a mold out of urethane or similar material, and vacuum sealing ABS plastic or other suitable material about the mold. The plastic member can then be trimmed and cut to provide the desired edges and/or openings. It will be appreciated that the positioning and retaining of gauges within the cavity created by securing the parapet member and the rampart member, as well as the process steps of securing the assembly in place within a vehicle interior may occur in a variety of orders. For example, in one embodiment of the present invention, a stud plate and the dash surface are cleaned with alcohol or similar method. Next, the stud plate is bolted to the rampart member along the raised bottom platform 34. Double-sided tape can then be applied to the parapet member and other areas of the device. Next, the parapet member is placed on the dashboard so the back tabs 42 of the parapet member aligns with the vent holes in the original equipment dashboard. The back 44 of the parapet member is then flexed so that the back edge flaps or tabs 42 snap into place in the desired vent holes of the dash. With the parapet member in place, the front of the rampart member 15 is then lifted and the double-sided tape is exposed (e.g., by removing the tape liner), and the rampart member and parapet member are then pressed down onto the dash in order to engage the tape. The nuts are then removed from the stud plate and the rampart member is removed from the dash, leaving the parapet member in place. At this point, the parapet member can be pressed again downwardly onto the dash to ensure a good tape seal. Next, the gauges to be inserted in the rampart member can be wired and loosely placed between the dashboard and the parapet member. In one embodiment of the present invention, the wiring can be run through the back vent holes on the original equipment dashboard. The parapet bolts can be tightened by going through the left and right gauge openings in the rampart member. The gauges can then be press fit into the rampart member after the bolts are tightened.

In another embodiment of the present invention, the parapet member and rampart member may be secured together, and then gauges fed through openings 35, wiring first. Then the rampart member may be secured to the vehicle, such as against the dashboard, with the wiring extending through notches 39 and up against the dashboard or through the vent openings so as to effectuate concealment.

The particular dimensions of the parapet member and rampart member and their elemental components can, in one embodiment, be customized depending upon the target vehicle make and model and the desired location within the target vehicle.

It should be understood that the foregoing description and examples are only illustrative of the present invention; the optimum dimensional relationships for the parts of the invention, including variations in size, materials, shape, form, function and the manner of operation, assembly and use, are deemed readily apparent to one skilled in the art, and all equivalent relationships to those illustrated in the drawings and described in the specification are intended to be encompassed by the present invention. Thus, various alternatives and modifications can be devised by those skilled in the art without departing from the invention. Accordingly, the present invention is intended to embrace all such alternatives, modifications, and variances that fall within the scope of the appended claims.

What is claimed and desired to be secured by Letters Patent is:

1. An above-dash gauge display mount assembly, comprising:
a rampart member having a face portion with a top edge, a left edge and a right edge, a pair of side beard segments integrally formed with and extending outwardly from the face portion left and right edges, respectively, a substantially flat bottom segment and at least one gauge frame member forming an opening through the face portion; and
a parapet member securable to the rampart member, the parapet member having a shroud member extending outwardly of the face portion of the rampart member.

2. The mount assembly of claim 1 wherein the rampart member further includes a head platform portion extending from a top edge of the face portion.

3. The mount assembly of claim 2 wherein the shroud member includes a front facing wall portion and a rampart engaging wall portion bent back from the front facing wall, and further wherein the head platform portion of the rampart member cooperatively engages the rampart engaging wall portion.

4. The mount assembly of claim 1 wherein said the gauge frame member is configured to receive an instrument.

5. The mount assembly of claim 1 further including mounting means for securing the rampart and the parapet member to a vehicle dashboard mounting surface.

6. A method of adding an additional gauge or other instrument to a vehicle having a dashboard, comprising the steps of:
providing a rampart member having a face portion with a top edge, a left edge and a right edge, a pair of side beard segments integrally formed with and extending outwardly from the face portion left and right edges, respectively, a substantially flat bottom segment and at least one gauge frame member forming an opening through the face portion;
providing a parapet member securable to the rampart member, the parapet member having a shroud member extending outwardly of the face portion of the rampart member; and
securing the rampart member and the parapet member to a vehicle dashboard.

7. A gauge display assembly, comprising:
a rampart configured so as to reside along the outer surface of an existing vehicle dashboard, the rampart including at least one gauge frame member and a face portion; and
a parapet member secured to the rampart, with the parapet member having a shroud portion overhanging the rampart face portion, and at least one tab along a back surface thereof for mating with an opening in the existing vehicle dashboard.

8. The gauge display assembly of claim 7, wherein the gauge frame members have an outer surface which is substantially coplanar with the rampart member face portion.

9. The gauge display assembly of claim 7, wherein the gauge frame members extend outwardly from the rampart member face portion.

10. The gauge display assembly of claim 9, wherein the gauge frame members extend at an angle to the normal line extending from the rampart member face portion.

11. The gauge display assembly of claim 7 wherein the parapet member includes a top surface, and where the shroud member includes a front facing wall portion and a rampart engaging wall portion bent back from the front facing wall so as to be substantially parallel with the top surface.

12. The gauge display assembly of claim 7 wherein the rampart member includes a head platform portion extending from a top portion of the face portion.

13. The gauge display assembly of claim 11 wherein the rampart member includes a head platform portion extending from a top portion of the face portion, and wherein the head platform portion cooperatively engages the rampart engaging wall of the shroud member.

14. The gauge display assembly of claim 7 wherein the rampart member further includes side beard segments and a bottom segment which abut a vehicle mounting surface when installed.
